(19) United States
(12) Patent Application Publication
(10) Pub. No.: US 2010/0060929 A1
(43) Pub. Date: Mar. 11, 2010

(54) IMAGE FORMING APPARATUS AND IMAGE FORMING METHOD

(75) Inventor: Shinji Koizumi, Mishima-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/556,014

(22) Filed: Sep. 9, 2009

Related U.S. Application Data
(60) Provisional application No. 61/095,478, filed on Sep. 9, 2008.

(51) Int. Cl. G06F 3/12

(52) U.S. Cl. 358/1.15

(57) ABSTRACT

A digital multi function peripheral as an image forming apparatus reads, if an external storage device is connected to an external interface, a print data file including setting information concerning printing and image data for printing from the external storage device connected to the external interface, receives an instruction for change to a print setting different from a print setting based on the setting information included in the print data file read from the external storage device, and prints, if the instruction for change of the print setting is not received, the image data for printing included in the print data file according to the print setting based on the setting information of the print data file and printing, if the instruction for change of the print setting is received, the image data for printing included in the print data file according to a print setting designated by a user.

### CROSS-REFERENCE TO RELATED APPLICATION

This application claims the benefit of U.S. Provisional Application No. 61/095,478, filed Sep. 9, 2008.

### TECHNICAL FIELD

The present invention relates to image forming apparatuses such as a copying machine, a printer, and a digital multi function peripheral having a function of connection to an external storage device carried by a user such as a USB (Universal Serial Bus) memory device.

### BACKGROUND

In recent years, an increasing number of image forming apparatuses such as copying machines, printers, and digital multi function peripherals have a function of connection (external interfaces) to various external storage devices. For example, most of digital multi function peripherals in recent years include, as external interfaces, USB interfaces for connecting a USB memory device as an external storage device carried by a user. A digital multi function peripheral having a USB interface has a function of using a USB memory connected to the USB interface by a user. For example, the digital multi function peripheral having the USB interface has a function of printing image data stored by the USB memory connected to the USB interface (a USB direct print function) by a user. The function of printing image data stored in an external storage device connected to an image forming apparatus by a user in this way is referred to as direct print function.

In the past, with the direct print function of the image forming apparatus, the image forming apparatus performs printing by acquiring an exclusive print file corresponding to the printing from the external storage device. In other words, the image forming apparatus in the past cannot perform printing with a setting different from a print setting for the print file stored in the external storage device.

### SUMMARY

According to one aspect of the invention, there is provided an image forming apparatus including: an external interface configured to connect to an external storage device; a reading unit configured to read, if the external storage device is connected to the external interface, a print data file including setting information indicating a print setting and image data for printing from the external storage device connected to the external interface; an operation unit configured to receive an instruction for change to a print setting different from the print setting based on the setting information included in the print data file read from the external storage device by the reading unit; and a printer configured to print, if the operation unit does not receive the instruction for change of the print setting, the image data for printing included in the print data file according to the print setting based on the setting information of the print data file and prints, if the operation unit receives the instruction for change of the print setting, the image data for printing included in the print data file according to a print setting designated by a user.

According to another aspect of the invention, there is provided an image forming apparatus including: an external interface configured to connect to an external storage device; a reading unit configured to read, if the external storage device is connected to the external interface, a print data file stored by the external storage device; a template acquiring unit configured to acquire template files indicating print setting information including various setting items applicable to printing of image data included in the print data file read by the reading unit; an operation unit for selecting one template file out of the template files acquired by the template acquiring unit; and a printer configured to print the image data of the print data file read by the reading unit according to a print setting based on the template file selected by the operation unit.

According to still another aspect of the invention, there is provided an image forming method including: reading, if an external storage device is connected to an external interface, a print data file including setting information concerning printing and image data for printing from the external storage device connected to the external interface; receiving an instruction for change to a print setting different from a print setting based on the setting information included in the print data file read from the external storage device; and printing, if the instruction for change of the print setting is not received, the image data for printing included in the print data file according to the print setting based on the setting information of the print data file and printing, if the instruction for change of the print setting is received, the image data for printing included in the print data file according to a print setting designated by a user.

According to still another aspect of the invention, there is provided an image forming method including: reading, if an external storage device is connected to an external interface, a print data file stored by the external storage device; acquiring template files indicating print setting information including various setting items applicable to printing of image data included in the read print data file; and printing, if one template file is selected out of the acquired template files, the image data of the print data file read from the external storage device according to a print setting based on the selected template file.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram of an external configuration example of a digital multi function peripheral (MFP) as an image forming apparatus having an interface to which an external storage device can be connected;

FIG. 2 is a schematic block diagram of a configuration example of the digital multi function peripheral;

FIG. 3 is a schematic diagram of the structure of the prn file;

FIG. 4 is a flowchart for explaining a processing procedure of direct print in the digital multi function peripheral;

FIG. 5 is a diagram of an example of an operation screen displayed if a prn file is selected;

FIG. 6 is a diagram of a display example of a template selection screen; and

FIG. 7 is a diagram of a display example of a print setting screen.

### DETAILED DESCRIPTION

An embodiment of the invention is explained in detail below with reference to the accompanying drawings.

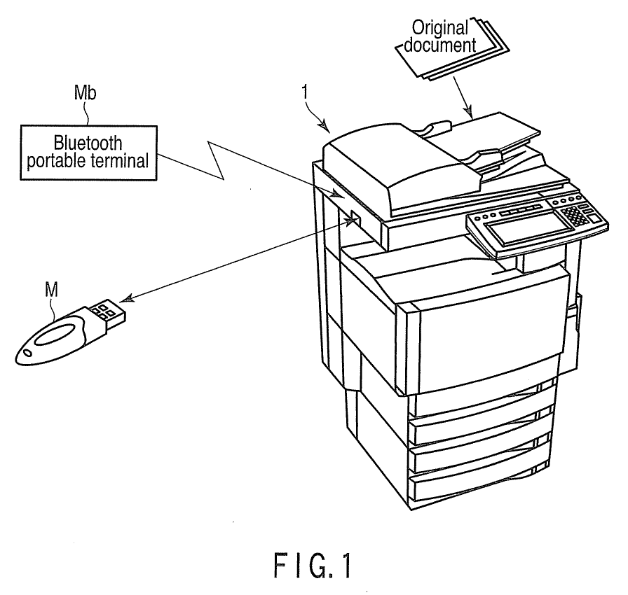

FIG. 1 is a diagram of an external configuration example of a digital multi function peripheral (MFP) as an image forming apparatus 1 having interfaces to which an external connection memory Ma or a radio terminal Mb as an external storage device can be connected. The digital multi function peripheral 1 has functions of a copying machine, a printer, a scanner, a facsimile, and a network communication apparatus. For example, the digital multi function peripheral 1 executes processing such as scanning, printing, and copying according to operation by a user.

In the digital multi function peripheral 1 according to this embodiment, the external connection memory Ma and the radio terminal Mb are assumed as external storage devices that can be connected to the digital multi function peripheral 1 by user operation. Specifically, the digital multi function peripheral 1 has an external interface to which the external connection memory Ma can be connected and an external interface (a radio communication interface) to which the radio terminal Mb can be connected by radio communication.

The external connection memory Ma as the external storage device is an electronic device having a function of being physically connected to the external interface of the digital multi function peripheral 1 by the user. For example, the external connection memory Ma is a portable external storage device such as a memory device (a USB memory device, a memory card, etc.), a mobile PC, a portable information terminal, a cellular phone, or an IC card having an interface corresponding to a specified connection system such as USB.

The digital multi function peripheral 1 has a radio communication interface that performs radio communication with the radio terminal Mb. The radio terminal Mb is an electronic device having a function of making connection to the digital multi function peripheral 1 by radio communication on an ad-hoc basis according to the operation by the user. The radio terminal Mb is a portable radio communication terminal such as a mobile PC, a portable information terminal, a cellular phone, or an IC card having a radio communication function by a specified radio communication system such as Bluetooth. In the following explanation, the electronic devices such as the external connection memory Ma and the radio terminal Mb that can perform communication with the digital multi function peripheral 1 according to the operation by the user are referred to as external storage devices.

As functions that can be executed by using the external storage devices, the digital multi function peripheral 1 has, for example, a function of printing image data stored by the external storage devices (direct print) and a function of storing scanned image data in the external storage devices (scan to memory). The “direct print” is a function of capturing image data from the external storage devices and printing an image on a sheet. A “scan to memory” is a function of storing image data obtained by scanning an original document in the external storage devices. In the external storage devices, authentication data for performing user authentication may be stored or user setting information and the like may be stored.

A configuration of the digital multi function peripheral 1 is explained below.

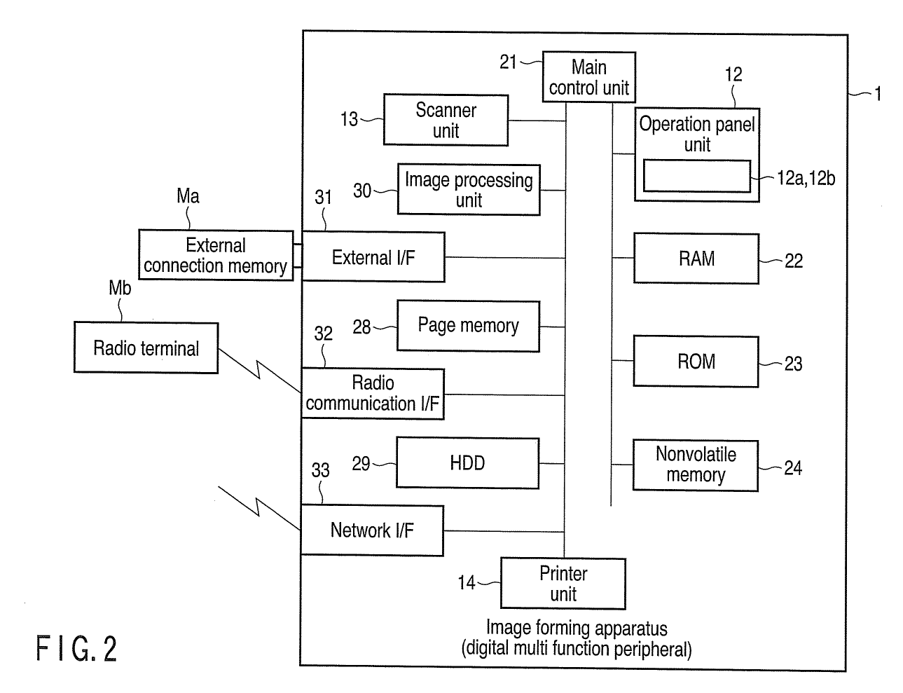

FIG. 2 is a schematic block diagram of a configuration example of the digital multi function peripheral 1.

As shown in FIG. 2, the digital multi function peripheral 1 includes an operation panel 12, a scanner unit 13, a printer unit 14, a CPU (Central Processing Unit) (a main control unit) 21, a RAM (Random Access Memory) 22, a ROM (Read Only Memory) 23, a nonvolatile memory 24, a page memory 28, a hard disk drive (HDD) 29, an image processing unit 30, an external interface (I/F) 31, a radio communication interface (I/F) 32, and a network interface (I/F) 33.

The operation panel 12 is a user interface to which an operation instruction from the user is input. The operation panel 12 includes hard keys such as a ten key and a display unit 12a incorporating a touch panel 12b. Operation guidance, touch keys (icons) that can be selected with the touch panel 12b, and the like are displayed on the display unit 12a of the operation panel 12. For example, the operation panel 12 detects, through the touch panel 12b, that the user touches the touch keys (the icons) displayed on the display unit 12a. In this case, the operation panel 12 notifies the main control unit 21 of a result of the detection of the touch on the touch key.

The scanner unit 13 functions as an image reading unit that converts an image on a document surface into image data. The scanner unit 13 converts, for example, an image of an original document into color or monochrome digital image data. The scanner unit 13 includes a scanning unit (not shown in the figure) that optically scans a document surface and a photoelectric conversion unit (not shown in the figure) such as a CCD line sensor that converts reflected light from the document surface optically scanned by the scanning unit into an electric signal.

The printer unit 14 forms an image on a sheet as an image forming medium. The printer unit 14 includes a conveying unit (not shown in the figure) that conveys the sheet and an image forming unit (not shown in the figure) that forms a color image or a monochrome image on the sheet conveyed by the conveying unit. The printer unit 14 prints image data on the sheet on the basis of the control by the main control unit 21. For example, in copy processing, the printer unit 14 prints image data read from an original document by the scanner unit 13 on the sheet. In print processing, the printer unit 14 prints image data input by the external I/F 31 or the external communication I/F 32 on the sheet.

The main control unit 21 manages control of the entire digital multi function peripheral 1. The main control unit 21 realizes various kinds of processing and various functions by executing control programs stored in the ROM 23, the nonvolatile memory 24, the HDD 29, or the like. For example, the main control unit 21 realizes the copy processing by controlling the scanner unit 13 and the printer unit 14 with a control program for copying. The main control unit 21 realizes the print processing by controlling the external communication I/F 32 or the external I/F 31 and the printer unit 14 with a control program for printing.

The RAM 22 is a memory that temporarily stores data for work and stores data for reference. The ROM 23 is a non-rewritable nonvolatile memory. For example, control programs, control data, and the like for controlling the digital multi function peripheral 1 are stored in the ROM 23. The nonvolatile memory 24 is a rewritable nonvolatile memory. The nonvolatile memory 24 includes an EEPROM or a flash ROM. The nonvolatile memory 24 stores system setting information and the like.

The page memory 28 is a memory having a storage area in which image data for at least one page is expanded. The HDD 29 is a large capacity storage device. The HDD 29 is also used as a memory for backup of various data. The HDD 29 stores various setting data and management data. The HDD 29 also stores data received by the external I/F 31 or the external communication I/F 32 according to necessity, image data read by the scanner unit 13, and the like. The HDD 29 may store authentication information for user authentication.

The image processing unit 30 applies various kinds of image processing to image data. The image processing unit 30 performs image processing such as correction, compression, and expansion of image data. For example, if the image processing unit 30 functions as an image processing unit for a scanner, the image processing unit 30 applies image processing such as shading correction, gradation correction, and inter-line correction to image data read by the scanner unit 13. The image processing unit 30 may apply the image processing to image data read out from the page memory 28, image data read out from the HDD 29, image data input by the external I/F 31, and image data input by the external communication I/F 32.

The external I/F 31 is an interface that performs data input and output to and from the external connection memory Ma as the external storage device. The external I/F 31 includes an interface corresponding to a communication system of the external connection memory Ma connected by the user. It is assumed that the external I/F 31 is an interface that physically comes into contact with the external connection memory Ma and inputs data to and outputs data from the external connection memory Ma. Examples of the external I/F 31 include a USB interface. In the configuration example shown in FIG. 1, the digital multi function peripheral 1 has a USB interface as the external I/F 31 that realizes a function of making connection to a USB memory having a communication function by a USB.

The radio communication I/F 32 is an interface that performs radio communication with the radio terminal Mb as the external storage device. The radio communication I/F 32 performs radio communication with the radio terminal Mb according to the operation by the user. The radio communication I/F 32 is an interface that performs input and output of data according to a specified radio communication system. Examples of the radio communication I/F 32 include a Bluetooth interface that performs radio communication by a Bluetooth system. In the configuration example shown in FIG. 1, the digital multi function peripheral 1 includes the Bluetooth interface as the radio communication I/F 32 that realizes the function of making connection to the radio terminal Mb.

The network I/F 33 is an interface that performs network communication. The network I/F 33 is, for example, an interface that performs data communication with an apparatus connected to a local area network (LAN) via a network cable or radio communication.

The direct print function of the digital multi function peripheral 1 is explained.

The direct print function is a function of printing, on a sheet, an image based on image data acquired from an external storage device. The digital multifunction peripheral 1 has, as the direct print function, a function of printing, on a sheet, an image based on a printer-driver processed file (e.g., xxx.prn format) generated by a not-shown PC using a printer driver for the digital multi function peripheral. The digital multi function peripheral 1 may have, as the direct print function, a function of printing, on a sheet, an image based on an image file of an application format matching the digital multi function peripheral.

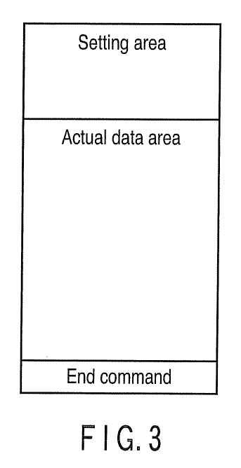

The printer-driver processed file (hereinafter referred to as prn file) includes data of an image that should be printed and print setting information. FIG. 3 is a schematic diagram of the structure of the prn file. As shown in FIG. 3, the prn file has a setting area in which information indicating various print settings is stored and an actual data area in which image data that should be printed on a sheet is stored. In an example of the structure shown in FIG. 3, an end point of the actual data area is indicated by an end command. If such a prn file is acquired, the digital multi function peripheral 1 can print image data stored in the actual data area on a sheet according to a print setting based on the setting information stored in the setting area.

The prn file is generated by a printer driver application program for the digital multi function peripheral 1 executed by a personal computer operated by a user (a user PC). A user who performs the direct print generates a prn file using the printer driver in the user PC. The user stores the generated prn file in the external storage device. The user connects the external storage device in which the prn file is stored to the digital multi function peripheral 1. The digital multi function peripheral 1 can perform the direct print by capturing the prn file from the external storage device. The digital multi function peripheral 1 that can perform the direct print prints an image based on image data of the prn file on a sheet according to an instruction of the user.

If the direct print function of the digital multi function peripheral 1 also corresponds to an image data file of an application format, the user who performs the direct print may store an image data file of a format corresponding to the direct print in the external storage device. If the external storage device in which the image data file of the format corresponding to the direct print is stored is connected to the digital multi function peripheral 1, the digital multi function peripheral captures the image data file from the external storage device and requests the user to perform print setting and the like. If the user instructs the print setting and print start, the digital multi function peripheral 1 performs the direct print using the image data file.

Template files for print settings in the direct print are explained.

In the digital multi function peripheral 1, the user can designate a print setting in the direct print from template files in which information concerning print settings is stored. The template files are files in which information concerning print settings in the digital multi function peripheral 1 is stored. In the template files, setting information concerning printings such as a print surface, magnification, a color mode, and a print layout is stored. Specifically, one print setting including various print setting items is stored in a template file.

The template files of the print settings may be generated by the user PC according to the operation by the user, may be generated by the digital multi function peripheral 1 according to the operation by the user, or may be preinstalled in the digital multi function peripheral 1. For example, the user PC executes an application for template generation to thereby generate template files in which print setting information designated by the user is stored. In this case, a computer-executable application program for template generation is provided to the user. The template files may be generated by a printer driver for the digital multi function peripheral 1 executed by the user PC. In this case, a printer drive for the digital multi unction peripheral 1 including a template generating function is provided to the user. The digital multi function peripheral 1 may store, as templates, print settings input by the user on the operation panel 12 to thereby provide a function of generating template files.

The template files may be stored in the external storage device, may be stored in advance in a storing unit (the nonvolatile memory or the HDD) in the digital multi function peripheral 1, or may be stored in advance in an external server with which the digital multi function peripheral 1 can communicate via the network I/F 33 or the like. In any form of the storage, the digital multi function peripheral 1 reads the template files if the external storage device is connected by the user. Specifically, if the external storage device is connected according to the operation by the user, the digital multi function peripheral 1 acquires template files that the user can use and presents print settings stored in the acquired template files to the user.

Template files that each of users can use may be set or all the users may share template files. For example, the digital multi function peripheral 1 can provide only a user who succeeds in user authentication with template files for which allowable users are set. The template files acquired from the external storage device may be provided without user authentication even if the template files are the template files for which allowable users are set.

A flow of processing of the direct print in the digital multi function peripheral 1 is explained below.

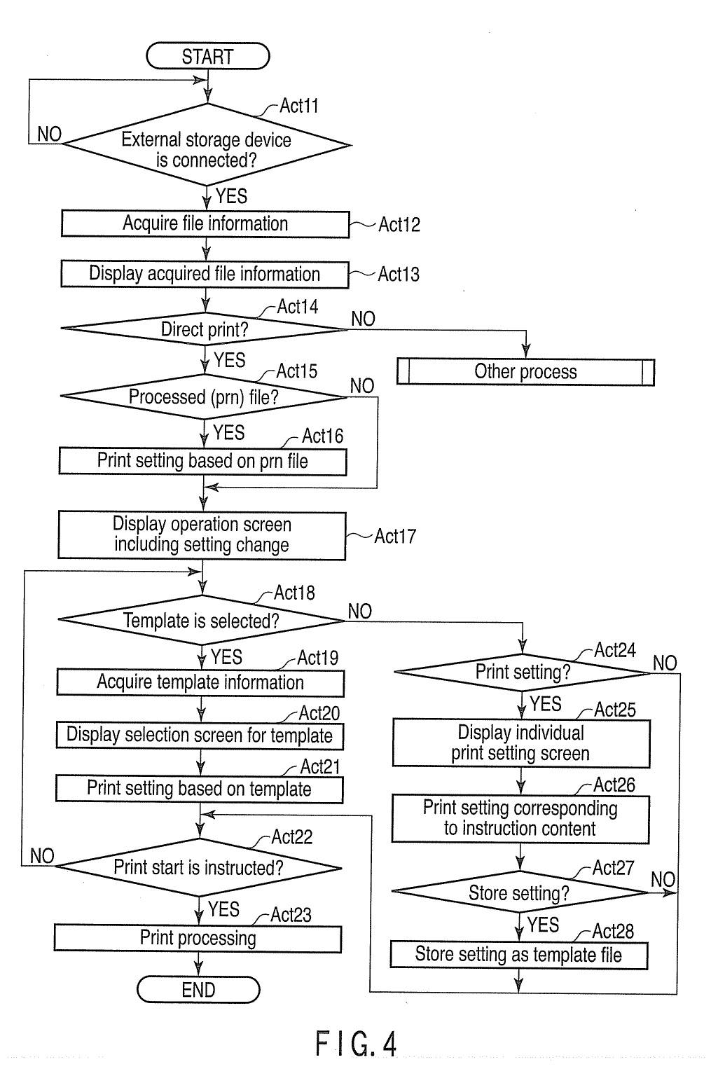

FIG. 4 is a flowchart for explaining a processing procedure for the direct print in the digital multi function peripheral 1.

If the external connection memory Ma is connected to the external I/F 31 or if the radio terminal Mb is connected to the radio communication I/F 32, the main control unit 21 of the digital multi function peripheral 1 acquires information concerning files stored in the connected external connection memory Ma or radio terminal Mb (external storage device) (Act 12). If information concerning the files is acquired from the external storage device, the main control unit 21 displays the information concerning the files stored in the external storage device on the display unit 12a of the operation panel 12 (Act 13).

The information concerning the files (icons of the files) displayed on the display unit 12a are displayed in a state selectable by the user on the touch panel 12b. In this case, the main control unit 21 displays, as a list, files as targets of the direct print among the files stored in the external storage device. The main control unit 21 may display, as a list, all the files stored in the external storage device or may display the files together with information indicating entire management structure.

If the user selects a file for the direct print from the files displayed on the display unit 12a (YES in Act 14), the main control unit 21 determines whether the selected file is a printer-driver processed file (a prn file) (Act 15). If the selected file is the prn file (YES in Act 15), the main control unit 21 enables a print setting on the basis of print setting information stored in a setting area of the prn file (Act 16).

If the print setting based on the prn file selected by the user is enabled, the main control unit 21 displays, on the display unit 12a, an operation screen for receiving the start of printing by the print setting or a change of the print setting (Act 17). If the user select a file other than the prn file (a file of an application format) as the file for the direct print (NO in Act 15), the main control unit 21 displays an operation screen for receiving a print setting on the display unit 12a (Act 17).

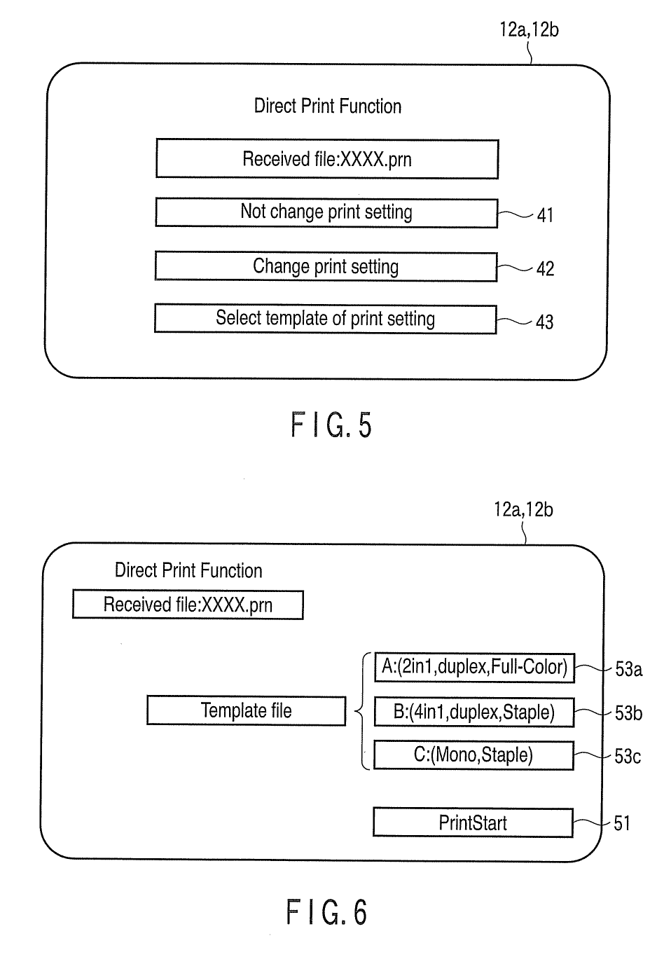

FIG. 5 is a diagram of an example of the operation screen displayed on the display unit 12a if the user selects the prn file.

In the display example shown in FIG. 5, the display unit 12a displays information indicating the selected file, an icon 41 for instructing print start, an icon 42 for instructing a change of the print setting, and an icon 43 for instructing a change of the print setting by a template. The icons 41, 42, and 43 function as buttons selectable by the touch panel 12b. The icon 41 is a button for instructing print start without changing the present print setting. The icon 42 is a button for instructing a change of the print setting. The icon 43 is a button for instructing a change of the print setting by a template.

If the print start is instructed on the operation screen displayed in Act 17 (e.g., if the icon 41 is touched in the display example shown in FIG. 5) (YES in Act 22), the main control unit 21 proceeds to Act 23 and prints image data of the file (the prn file or the file of the application format) selected by the user in the present print setting (Act 23). If the prn file is selected out of the files read from the external storage device, the digital multi function peripheral 1 is in a state of the print setting based on the prn file. In other words, if the user instructs print start without instructing a setting change after selecting the prn file, the digital multi function peripheral 1 executes print processing based on the print setting of the selected prn file.

If the print setting by a template is instructed on the operation screen displayed in Act 17 (e.g., if the icon 43 is touched in the display example shown in FIG. 5) (YES in Act 18), the main control unit 21 performs processing for acquiring usable template files (Act 19). As explained above, template files may be stored in the external storage device, may be stored in the storing unit in the digital multi function peripheral 1, or may be stored in the external server with which the digital multi function peripheral 1 can communicate. Therefore, the main control unit 21 acquires the template files from the external storage device, the storing unit in the digital multi function peripheral 1, or the external server with which the digital multi function peripheral 1 can communicate. For example, if the template files are stored in the external storage device, the main control unit 21 acquires a list of usable template files from the external storage device. If the template files are stored in the storing unit in the digital multi function peripheral 1, the main control unit 21 acquires a list of usable template files from the storing unit in the digital multi function peripheral 1.

If the list of usable template files is acquired, the main control unit 21 displays the acquired list of template files on the display unit 12a as a selection screen for a print setting template (Act 20). The display unit 12a displays, for example, icons of templates selectable by the user using the touch panel as a template selection screen.

FIG. 6 is a diagram of a display example of the template selection screen.

The display example shown in FIG. 6 is an example in which the template selection screen is displayed on the operation screen for the direct print function. The operation screen shown in FIG. 6 may be displayed instead of the display example shown in FIG. 5 or may be displayed if selection of a template for print setting is instructed on the operation screen shown in FIG. 5.

In the display example shown in FIG. 6, the display unit 12a displays information indicating a file selected by the user, an icon 51 for instructing print start, and template icons 53a, 53b, and 53c corresponding to template files. The template icons 53a, and 53b, and 53c are buttons selectable by the touch panel 12b. If the user touches the icon 51 in a state in which any one of the template icons 53a, 53b, and 53c is selected, the digital multi function peripheral 1 prints image data of the file designated by the user according to a print setting of the selected template file.

Specifically, if the user selects any one of the template files on the template selection screen, the main control unit 21 enables the print setting based on the selected template file (Act 21). For example, if the user selects any one of the template files in a state in which one prn file is selected as a file of the direct print, the main control unit 21 rewrites information concerning a setting area in the prn file with setting information based on the selected template file. In this case, the main control unit 21 performs print setting according to the setting information based on the template file written in the setting area of the prn file (Act 16). If print start is instructed in a state in which a setting change based on the template file selected by the user is performed (YES in Act 22), the main control unit 21 prints image data of the file selected by the user (the prn file or the file of the application format) according to setting content of the template file selected by the user (Act 23).

If a change of the print setting by user operation is instructed on the operation screen displayed in Act 17 (e.g., if the icon 42 is touched in the display example shown in FIG. 5) (YES in Act 24), the main control unit 21 displays a print setting screen on which the user designates various setting items (Act 25). The print setting screen is a screen on which the user designates arbitrary setting content concerning the various setting items.

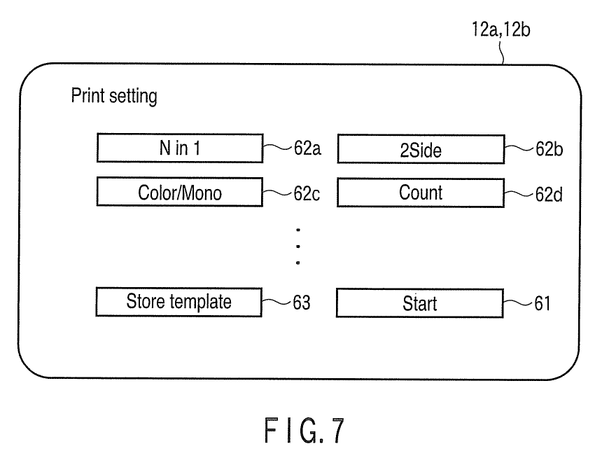

FIG. 7 is a diagram of a display example of the print setting screen. In the display example of the print setting screen shown in FIG. 7, the display unit 12a displays an icon 61 for instructing print start, icons 62 (62a, 62b, 62c, 62d, . . . ) for instructing various setting items, and an icon 63 for instructing storage of setting content in a template. In the display example shown in FIG. 7, the user selects an icon of an item, a print setting of which the user desires to change. If the user selects any one of the icons, the main control unit 21 shifts to detailed setting processing for the selected item. If setting changes in the items are completed, the user instructs print start with the icon 61.

Setting content instructed by the user operation explained above may also be stored in the external storage device or the storing unit in the digital multi function peripheral 1 as a template file. This may be realized by storing information indicating content of a print setting as a template file (Act 28), if the icon 63 is touched after the print setting is input (YES in Act 27).

If print setting is instructed on the print setting screen explained above, the main control unit 21 enables a print setting corresponding to instruction content (Act 26). For example, if a print setting of a prn file selected as a file of the direct print is changed, the main control unit 21 rewrites information in a setting area of the prn file with setting information corresponding to instruction content of the user. In this case, the main control unit 21 performs print setting according to the setting information written in the setting area of the prn file (Act 26). If print start is instructed in a state in which such print setting is performed, the main control unit 21 prints image data of the file (the prn file or the file of the application format) selected by the user according to the print setting instructed by the user (Act 23).

As explained above, the digital multi function peripheral 1 has the function of changing, if a printer-driver processed file including print setting information is received as a file for the direct print from the external connection memory such as a USB memory connected to the external I/F or the radio terminal such as a Bluetooth terminal connected to the radio communication I/F by communication, a print setting included in the printer-driver processed file to setting content designated by the user.

The digital multi function peripheral 1 has the function of performing print setting for the file for direct print on the basis of setting information stored in a template file selected by the user. For example, the digital multi function peripheral 1 can apply printing based on the setting information of the template file selected by the user to the printer-driver processed file including the print setting information.

With such a digital multi function peripheral, the user easily change a file printed in the direct print to a favorite print setting and print the file.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
an external interface configured to connect to an external storage device;
a reading unit configured to read, if the external storage device is connected to the external interface, a print data file including setting information indicating a print setting and image data for printing from the external storage device connected to the external interface;
an operation unit configured to receive an instruction for change to a print setting different from the print setting based on the setting information included in the print data file read from the external storage device by the reading unit; and
a printer configured to print, if the operation unit does not receive the instruction for change of the print setting, the image data for printing included in the print data file according to the print setting based on the setting information of the print data file and prints, if the operation unit receives the instruction for change of the print setting, the image data for printing included in the print data file according to a print setting designated by a user.

2. The apparatus according to claim 1, wherein the external interface is an external interface having a connection terminal to which the user connects the external storage device at arbitrary timing.

3. The apparatus according to claim 2, wherein the external interface is a USB interface.

4. The apparatus according to claim 1, wherein the external interface is a radio communication interface connected by radio communication with a radio terminal as the external storage device.

5. The apparatus according to claim 4, wherein the radio communication interface is an interface that communicates with the radio terminal by radio through short-distance radio communication conforming to a specified protocol.

6. The apparatus according to claim 1, further comprising a template acquiring unit configured to acquire template files indicating print setting information including various setting items, wherein
the operation unit receives a change of the print setting by one template file selected out of the template files acquired by the template acquiring unit.

7. The apparatus according to claim 6, wherein the template acquiring unit acquires a template file from the external storage device connected to the external interface.

8. The apparatus according to claim 6, further comprising a storing unit configured to store template files indicating print setting information including various setting items, wherein
the template acquiring unit acquires a template file from the storing unit.

9. An image forming apparatus comprising:
an external interface configured to connect to an external storage device;
a reading unit configured to read, if the external storage device is connected to the external interface, a print data file stored by the external storage device;
a template acquiring unit configured to acquire template files indicating print setting information including various setting items applicable to printing of image data included in the print data file read by the reading unit;
an operation unit for selecting one template file out of the template files acquired by the template acquiring unit; and
a printer configured to print the image data of the print data file read by the reading unit according to a print setting based on the template file selected by the operation unit.

10. The apparatus according to claim 9, wherein the external interface is an external interface having a connection terminal to which the user connects the external storage device at arbitrary timing.

11. The apparatus according to claim 10, wherein the external interface is a USB interface.

12. The apparatus according to claim 9, wherein the external interface is a radio communication interface connected by radio communication with a radio terminal as the external storage device.

13. The apparatus according to claim 12, wherein the radio communication interface is an interface that communicates with the radio terminal by radio through short-distance radio communication conforming to a specified protocol.

14. The apparatus according to claim 9, wherein the template acquiring unit acquires a template file from the external storage device connected to the external interface.

15. The apparatus according to claim 9, further comprising a storing unit configured to store template files indicating print setting information including various setting items, wherein
the template acquiring unit acquires a template file from the storing unit.

16. The apparatus according to claim 9, wherein
the print data file is a file including setting information concerning printing and image data for printing,
the apparatus further includes a processing unit configured to rewrite, if one template file is selected by the operation unit, the setting information of the print data file with setting information based on the selected template file, and
the printer rewrites the setting information of the print data file read by the reading unit with the setting information based on the template file selected by the operation unit and prints the image data for printing on the basis of the setting information after the rewriting.

17. An image forming method comprising:
reading, if an external storage device is connected to an external interface, a print data file including setting information concerning printing and image data for printing from the external storage device connected to the external interface;
receiving an instruction for change to a print setting different from a print setting based on the setting information included in the print data file read from the external storage device; and
printing, if the instruction for change of the print setting is not received, the image data for printing included in the print data file according to the print setting based on the setting information of the print data file and printing, if the instruction for change of the print setting is received, the image data for printing included in the print data file according to a print setting designated by a user.

18. The method according to claim 17, further comprising template files indicating print setting information including various setting items, wherein
the receiving the instruction for a change of the print setting is receiving the instruction for a change of the print setting if one template file is selected out of the acquired template files.

19. An image forming method comprising:
reading, if an external storage device is connected to an external interface, a print data file stored by the external storage device;
acquiring template files indicating print setting information including various setting items applicable to printing of image data included in the read print data file; and
printing, if one template file is selected out of the acquired template files, the image data of the print data file read from the external storage device according to a print setting based on the selected template file.

20. The method according to claim 19, wherein
the print data file is a file including setting information concerning printing and image data for printing,
the method further includes rewriting, if the one template file is selected, the setting information of the print data file with setting information based on the selected template file, and
the printing is printing the image data for printing on the basis of the setting information after the setting information of the print data file is rewritten with the setting information based on the selected template file.
